(19) United States
(12) Patent Application Publication
(10) Pub. No.: US 2026/0027570 A1
(43) Pub. Date: Jan. 29, 2026

(54) FIVE ISLAND FLUIDIC CIRCUIT FOR LOW TEMPERATURE PERFORMANCE OF ALCOHOL-BASED AQUEOUS MIXTURES

(71) Applicant: ABC TECHNOLOGIES, INC., New York (CA)

(72) Inventor: Alexander Dotzler, Potomac, MD (US)

(21) Appl. No.: 19/280,397

(22) Filed: Jul. 25, 2025

Related U.S. Application Data
(60) Provisional application No. 63/675,771, filed on Jul. 26, 2024.

(51) Int. Cl. B05B 1/08

(52) U.S. Cl. CPC B05B 1/08

(57) ABSTRACT

A fluidic geometry to produce uniform oscillating sprays is described. The geometry can be embodied as an insert, housing, or system in which an inlet feeds an interaction chamber. Four islands define the perimeter of an interaction chamber having a cloverleaf-like shape, with five power nozzles positioned symmetrically with narrowing walls feeding into this chamber. The chamber itself has a greater depth than the power nozzles owing to a step, and a fifth island is disposed on the central axis above the throat and beneath the upper-most, central power nozzle. This arrangement exhibits consistent cold and high temperature performance for a range of fluid compositions and operating conditions.

### CROSS REFERENCE TO RELATED APPLICATIONS

This application claims priority to U.S. provisional patent application Ser. No. 63/675,771 filed on Jul. 26, 2024, the entirety of which is incorporated by reference.

### FIELD OF INVENTION

This invention relates to fluidic systems, components, and apparatus capable of producing controllable, oscillating spray patterns and, more particularly, to a fluidic geometry to generate robust sprays, particularly those containing alcohol(s) mixed with aqueous-based cleaning fluids, at temperatures approaching or below the freezing point of water.

### BACKGROUND

U.S. Pat. No. 6,186,409 provides an example of a fluidic system colloquially known as having a “mushroom” configuration. In this patent, a chip or insert has a pattern of apertures formed within one of its surfaces, with the expectation that insert is sealingly received within housing that receives fluid, feeds the fluid into an inlet or plenum formed on the insert, and then has the outlet of the insert aligned with an aperture in the housing so that the housing dispenses a spray fan from that aperture. Owing to the geometric configuration formed on the insert, the dispensed spray may oscillate or otherwise possess specific characteristics. U.S. Pat. Nos. 7,472,848 and 7,267,290 describe further improvements and embodiments of other oscillating geometries and inserts.

“Reverse mushroom” iterations of this design can be found in U.S. Pat. Nos. 6,253,782; 11,305,297; 11,872,574; and 11,712,707. In these instances, mirror image power nozzles are positioned in the lower portions of interaction chamber, which itself is wider at the feed inlet at the top than it is at the outlet/throat positioned at the bottom (hence, the “reverse” nomenclature, as compared to the circuit in the preceding paragraph). The curving shape of the walls in the interaction chamber can be manipulated, as can the yaw/angle at which the spray is dispensed relative to the rectangular shape of the insert/chip. These configurations allow for further customization of spray performance, particularly at low temperatures.

U.S. Pat. Nos. 7,651,036 and 10,532,367 rely upon a fluidic circuit configuration referred to as a “three jet island”. Here, the chip/insert includes a pattern in which the interaction chamber is defined in its upper extremities by a pair of “islands” that divide fluid flow into three discrete channels, including a power nozzle at the top of the interaction chamber and mirror image power nozzles. Another island is positioned within the interaction chamber between the power nozzles and immediately below/adjacent to the top inlet. This configuration produces an oscillating spray.

Many other fluidic geometries are known, so that the mushroom configuration serves as merely one example. However, it is instructive insofar as it (like these other geometries) possesses the features needed to produce oscillating sprays. Specifically, the inlet/feed leads to a passage which optionally has a series of spaced apart posts that help to filter unwanted debris from the fluid. Downstream from these posts, the passage is defined and/or divided by features that direct fluid into the power nozzles, which constrict flow and eject side/angled jets into an interaction chamber. Upon entering this chamber, the fluid jets from the power nozzles interact to produce turbulent and shifting flow patterns. Thus, upon exiting through the outlet at the downstream edge of the insert, the fluid is dispensed as a fan-shaped cone in which a jet moves (i.e., oscillates) so as to create a spray that may be uniformly distributed or tailored to deliver greater volume along selected portions of the spray fan (i.e., the arcuate dispensing range covered by that circuit).

U.S. Pat. No. 9,987,639 describes structures that can be implemented in outlet/throat to produce specific effects, while United States' patent publication 2021/0114044 discloses features on and/or in the interaction chamber. All of these patents are also incorporated by reference.

All of the foregoing patents are incorporated by reference as background information.

In view of the foregoing, a fluidic geometry, insert, and/or system that produces reliable, oscillating sprays at a wide range of operating parameters (e.g., temperature, viscosity of fluid, low vs. high flow rates, desired size/shape/volumetric distribution of the spray fan, etc.) would be welcomed. Specifically, a geometry is needed that will produce uniform spray patterns while taking into account the various different fluids, flow rates, and operating temperatures commonly encountered by vehicles around the globe.

### SUMMARY OF INVENTION

A fluidic geometry is formed on insert and/or as part of a housing or system. Five power nozzles feed an interaction chamber, with adjacent power nozzles defining a series of dividers or islands disposed starting in the upstream half of that chamber and arrayed/extending toward the downstream end. An interaction chamber island, preferably triangular in shape with an apex oriented on the central axis of the insert but not otherwise defined by the aforementioned power nozzles, is disposed on the flat, upstream-facing portion of the interaction chamber floor.

The other islands defining/defined by the power nozzles are distributed around the perimeter of the interaction chamber. In one aspect, all the islands are symmetrical and/or evenly spaced so that one nozzle is positioned on the central axis between two top islands, a pair of mid-level nozzles positioned between a top island and a lower side or “power nozzle” (PN) island, and a pair of bottom-level nozzles transversely offset from and slightly above the throat.

While the geometry is formed on a major facing of a chip or planar member, the interaction chamber itself is sunken or set lower within the facing in comparison to the depth of the power nozzles, plenum/inlet, and other upstream features. The downstream portion of the interaction chamber, possibly including the two lower most power nozzles, gradually slopes upward at an angle so that the depth at the throat of the circuit is between the depth of the inlet and the maximum depth of the interaction chamber.

As compared to the conventional fluidic circuits noted above, this design relies on five power nozzles, five discrete islands, and only one throat. The extra two power nozzles (which are more than previous geometries for fluidic circuits, all as contemplated above) are positioned in a way to disrupt the formation of a laminar jet stream coming from the upper three power nozzles. This added turbulence creates the needed instability in the interaction chamber to facilitate the initial oscillation occurring at lower fluid velocities, and thus, lower pressure with the higher viscosity fluid. The resulting circuit/geometry exhibits excellent cold temperature performance, while delivering desired oscillation and spray fan characteristics, all as contemplated herein.

While specific aspects are depicted and described, it will be understood that the inventive concepts can be applied to produce a wide array of embodiments within the meaning of the foregoing claims, drawings, and description. As such, these elements should be read and understood in a manner consistent with the knowledge of an artisan in this field as of the original filing date noted herein.

### DESCRIPTIONS OF THE DRAWINGS

The appended drawings form part of this specification, and any information on/in the drawings is both literally encompassed (i.e., the actual stated values) and relatively encompassed (e.g., ratios for respective dimensions of parts, generalized comparatives, etc.). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure, including selected drawings which may be drawn to scale.

FIGS. 1A and 1B are identical three dimensional perspective images of the insert, showing the features etched into the top surface so as to produce the inventive fluidic circuit with the features contemplated herein. FIG. 1A includes shading along the depthwise facings to emphasize the changes in elevation of the islands, nozzles, and interaction chamber floor and sloping throat, whereas FIG. 1B is provided in conventional black and white line drawing.

FIG. 2 is a top plan view of the insert of FIGS. 1A and 1B.

FIGS. 3A and 3B are cross sectional views taken along a central axis of FIG. 2. In both, the downstream throat is positioned at the left edge, while the right portion of the insert (surrounded by posts) accommodates the inlet. FIG. 3A is shown in a three dimensional perspective view, while FIG. 3B is a side plan view to better emphasize the changes in depth, particularly in the interaction chamber and throat.

FIG. 4 is top schematic view with arrows representing anticipated flow patterns through the circuit (which is similar to the one shown in FIG. 2, but with larger power nozzle islands).

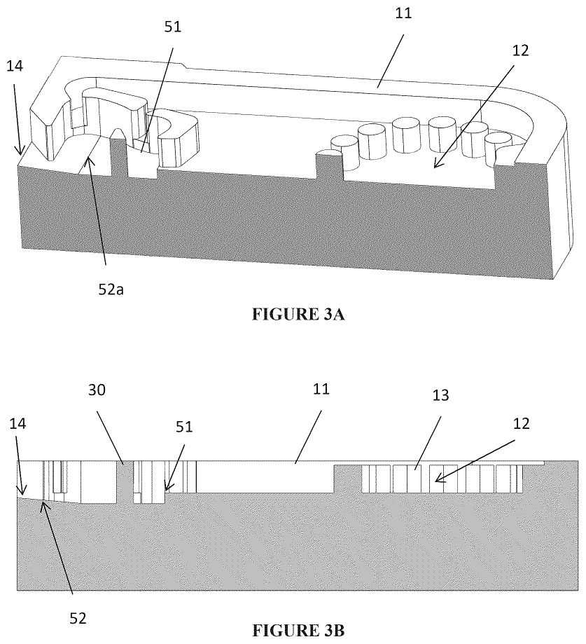

These dimensions, size, and spacing of the components depicted in FIGS. 1A, 1B, and 3A, 3B are drawn to scale, and a skilled person may discern comparative and absolute dimensions and ratios between such dimensions by taking appropriate measurements (beyond those specifically identified in the appendix). In addition to the stated values below, dimensions and angles identifiable within these Figures are incorporated as their absolute values, along with variations (including combinations and permutations to the extent ratios are disclosed) of plus or minus 5%, plus or minus 10%, or even up to plus or minus 20%.

### DETAILED DESCRIPTION

Operation of the invention may be better understood by reference to the detailed description, drawings, claims, and abstract—all of which form part of this written disclosure. While specific aspects and embodiments are contemplated, it will be understood that persons of skill in this field will be able to adapt and/or substitute certain teachings without departing from the underlying invention. Consequently, this disclosure should not be read as unduly limiting the invention(s).

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The fluidic geometry or circuit will be formed on/in the facing of an insert. The insert is usually a flat, planar object that is etched, molded, or otherwise constructed to define a flow path in which one or more inlets are disposed at one end of the insert with a single outlet disposed at the opposing end/edge. Thus, reference to “top” or “upstream” means in the direction of the inlet(s), while “bottom” or “downstream” trends toward the outlet. This orientation coincides with how the circuits are depicted in the drawings. Also, because the flow generally proceeds parallel to the planar surface on/in the insert, “axial” refers to the top-to-bottom or vertical direction in the drawings, whereas “transverse” is any line horizontal or width-wise line that perpendicularly intersects with an axial line drawn down the center of the insert. “Depth” refers to the thickness of the features etched into the major planar surface, and the transition in depth may occur according to step that is orthogonal to the major facing and/or along a sloping section, that is demarcated by a boundary or straight line along which a change (relative to the facing of the insert) begins or ends.

In one aspect, this invention consists of a fluidic circuit with 5 power nozzles, 5 islands, and 1 throat molded, etched, or otherwise formed on one of the major facings of the insert. The circuit is laid out symmetrically about the throat-feed axis, with one power nozzle directly on said axis, and 2 on either side. In addition to the extra power nozzles, a “cold step” is formed at the interface between the power nozzles (and other upstream portions) and the interaction chamber (and downstream portions), with the later having a greater depth in comparison to the former.

Without intending to be limited to any theory or mode of operation, the cold step is believed to serve two functions: 1) to increase turbulence in the interaction region, helping facilitate oscillation, and 2) to overcome some geometric constraints because the cumulative area covered by each power nozzle needs to be smaller than compared to the throat area. Also, because the surface area ratio of throat to power nozzle (at their respective narrowest points) can influence fluidic fan angle, the throat should be deeper than the power nozzles to attain the preferred characteristics identified herein. However, the cold step also tends to impact the aim of the fan spray. Specifically, fluid coming into the interaction region expands downward over the step and toward the floor as it progresses through the circuit, thereby introducing a downward velocity to the flow that must be accounted for to attain the desired spray fan pattern (e.g., a gradual incline to scale back the depth of the outlet, in comparison to the initial step-down in the interaction chamber, can be begin at or upstream from throat).

The shape of the interaction region, which follows along the cold step and the inner/downstream facings of the islands that define the interaction chamber, also plays a significant role. While the center portion of the interaction chamber bears similarities to previous numbered-island designs noted above, its perimeter/peripheral edges curve and undulate in a manner more characteristic of feedback circuits where channels from the interaction region divert flow out of the chamber and reverse/return it at a different point, usually upstream. Here, the bottom two power nozzles function independently but in parallel with the other power nozzles so that flow proceeds downstream through all five nozzles—from the inlet/feed area, around the islands, into the interaction chamber, and through the throat/outlet, with the combined effect of all five nozzles contributing toward the conditions necessary to produce the desired fan spray/output under the conditions contemplated herein.

Yet another advantage to the various aspects disclosed herein is that blockages, particularly at one of the bottom power nozzles, do not appear to significantly degrade the cold temperature oscillating spray. While the yaw of that spray fan occasionally is impacted in these conditions, the design (or even the user) can accommodate by altering aim/positioning of the outlet. In some aspects, this effect could itself be used to tailor the shape of the desired spray fan.

With reference to the FIGS. 1A through 4, the circuit 10 and insert/planar body 1 on which it is formed are preferably symmetrical about a central, vertical axis A-A. The circuit 10 comprises various features, with the throat 20, islands 30, and power nozzles 40 all creating mirror images in some aspects. In the same manner. The insert 1 has a cuboid or three-dimensional polygonal shape with a substantially flat planar orientation to provided opposing facings 2a, 2b. A fluidic circuit 10 (and all of its various features) is formed on at least one of the facings 2a, with the term “fluidic” understood to mean a device having features specifically selected and engineered to produce desired flow patterns in fluids passing through the circuit. The insert 1, including its geometry/circuit 10, can be formed via conventional injection molding, etching, additive manufacturing, and the like, relying on a wide area of materials based upon the selected methodology.

The circuit 10 is bounded by a barrier wall 11, with an inner facing 11a containing and directing fluid flow in the circuit. With reference to FIGS. 1A and 1B, it will be understood that the insert 1 can be fitted within a slotted housing or otherwise sealed by a separate component to enclose the circuit 10 along its open facing(s), except for inlet 12 and outlet 14. The boundary wall 11 itself includes parallel axial sections and rounded corners at both the top and the bottom of the circuit 10. In some aspects, the depth of the wall 11 remains constant.

The inlet 12 region is positioned at the top of the circuit flow, with flow provided from via an plenum formed with the housing or an aperture running between the facings 2a, 2b (not shown). A series of posts 13 may form a perimeter around the plenum/aperture where fluid is first introduced to the circuit 10, so as to serve as structural support and/or as a filter that prevent large particles from flowing downstream into the more narrow channels of the circuit. In some aspects, the posts 13 do not extend to the same height away from the floor of the circuit in comparison to the boundary wall 11 and islands 30, so as to allow for greater tolerances in manufacturing and/or to provide additional flow paths downstream from the inlet point (see FIG. 3B).

The outlet 14 is at the bottom of the circuit flow. The outlet 14 itself is formed as an interruption within the boundary wall 11. The oscillating spray fan will exit and emanate from the outlet 14, either in parallel with the direction of plane coinciding with facing 2a and/or at an angle to that plane. In certain aspects, the transverse open width of the outlet 14 at the very bottom edge significantly larger than the transverse width of the throat 20, usually at least twice the width and up to three times the width (with about 2.4 to 2.5 times being preferred). The sidewalls running from the narrowest point of the throat 20 out to the bottom edge of the outlet 14 are straight edges, although the throat itself may possess rounded edges as it transitions from the interaction chamber 50 facing to the outlet 14 facing.

Turning the specific features of the circuit itself, the interaction chamber 50 is defined by a series of islands 30 which are spaced apart to define power nozzles 40. A cold step 51 coincides with the openings for at least some of the power nozzles 40, while a sloping floor 52 reduces the depth of the chamber 50 as flow proceeds towards the throat 20. In some aspects, the transition point 52a at which the depth of the chamber 50 begins to decrease is a orthogonal to the axis A-A. The sloping floor 52 will slope at an angle of less than 15° and, in some aspects, about 5° relative to the flat floor of the interaction chamber 50.

The step 51 will drop at an angle that is within +/−10° perpendicular, with some aspects having the step orthogonal to the floor sections of the interaction chamber 50 and, separately, the upstream approaches (e.g., the inlet region 12 and the sections upstream of the islands 30). The comparative drop of the height will be about one half to one quarter relative to the depth of the upstream flow portions (i.e., those areas above the interaction chamber 50). However, it will be understood that the lower power nozzles 43 will have a shorter cold step because they are positioned within the sloping floor portion 52 of the chamber 50. Also, in comparison to nozzles 41, 42, the jets B emitted by the lower power nozzles are oriented upstream, although at an acute angle in comparison to the bottom edge of about 30° (+/−15° in selected aspects and +/−5° in further aspects). In contrast, the jet C from the central power nozzle 41 will flow downstream and parallel to the central axis A-A (+/−15° in selected aspects and +/−5° in further aspects) and the jets M from the midrange power nozzles are also directed downstream at an angle relative to the bottom edge.

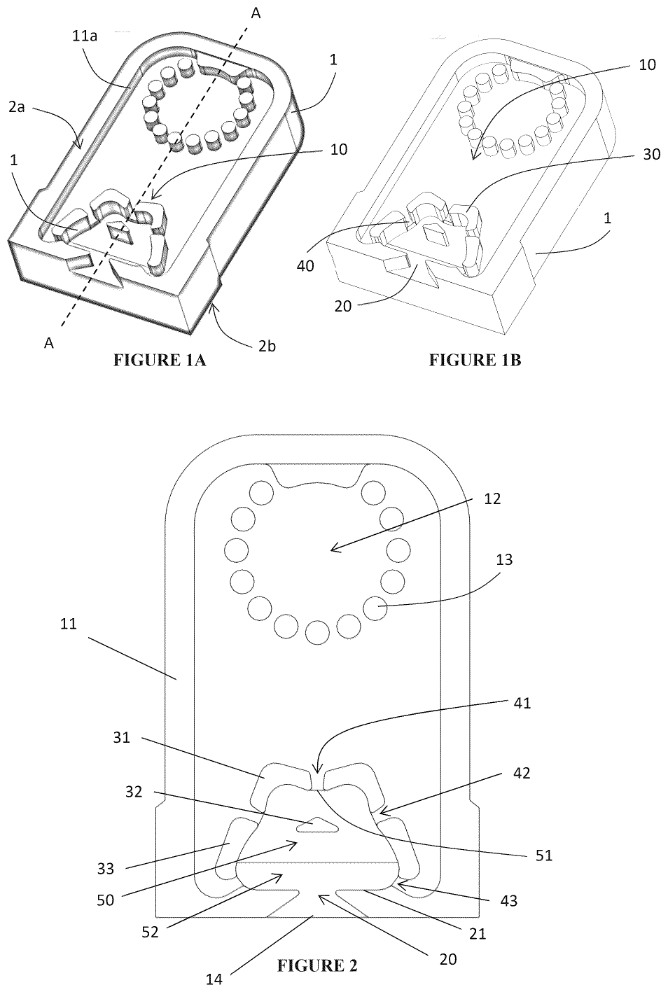

While it is generally understood that the structures and concepts disclosed as aspects of the invention can and will be adapted to meet particular needs, it is possible to provide more details on specific examples. With reference to the embodiments shown in FIGS. 2-3B, if the depth of the interaction chamber is 1 unit, the depth of the outlet at the edge of the insert will be between 0.85 and 0.95 units. In contrast, the upstream portions prior to the cold step 51 will generally have a depth of 0.70 to 0.80 units. Thus, the interaction chamber is the deepest, whereas the inlet and regions upstream of the cold step 51 will be most shallow and the depths of the sloping section and outlet will fall in between those two extremes.

Next, a portion of the islands 30 held to define the interaction chamber 50. Specifically, a pair of top/upper islands 31 and a pair of bottom/lower islands 33 define the chamber 50, as well as the central power nozzle 41, a pair of midrange power nozzles 42, and a pair of bottom power nozzles 43. As previously noted, some aspects of the invention call for mirror-image or symmetry for these features, although it is possible to deliberate create imbalance to the extent it might impart desired shape or flow characteristics to the final fan spray. Also as noted above, the shape of the interaction chamber is somewhat unique in comparison to reverse mushroom, three-jet island, and other circuits described above. Here, the interaction chamber includes a pair of downstream walls 21 bounding/defining the throat that run transversely and, in some aspects, perpendicular to the central axis A-A. These walls curve upward slightly before merging with the boundary wall 11 at each bottom corner of the chamber 50. The lower islands 33 possess a curved inner facing so as to define a slight bulge that represents the largest transverse width of the chamber 50. The upstream-most ends of the islands 33 angle back toward the central axis A-A/power nozzles 42, while the upper islands 31 possess an L- or C-shape that includes the largest axial length of the chamber (measured parallel to axis A-A relative to the flat bottom wall 21). In some aspects, the edges of the upper islands 31 angle back downward toward the central axis A-A/power nozzle 41. As a result, the overall shape of the chamber 50 possesses characteristics of both a conventional mushroom and a reverse mushroom, but with the upstream edge of the chamber 50 dipping downward toward the bottom along its central section (thereby bearing a slight resemblance to a four leaf clover shape).

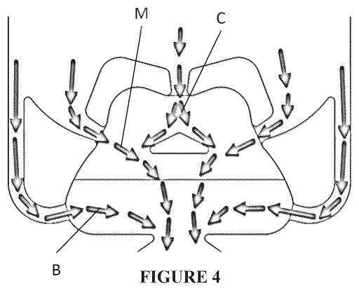

Another distinguishing feature is that a power nozzle island 32 is provided within the flat portion of the chamber 50 itself. This island has a rounded triangular shape, similar to an isosceles triangle. The top point of that triangle (which may include an angle, as shown, or a slightly rounded feature) is aligned on axis A-A or proximate to or within the jets C emanating from power nozzle 41, and it forms an obtuse angle between 110° and 160°, with selected aspects between 125° and 130° (+/− an additional) 10°. The bottom facing of the triangle is aligned parallel to the bottom wall 21, with the lower two points terminating proximate to or within the jets M created by the midrange power nozzles 42 (see FIG. 4). The bottom facing of island 32 is aligned proximate to a slightly downstream from the top and/or inner most edges of the lower islands 33. The bottom jets B from the lower power nozzles 43 will be directed at an angle toward the central portion of the chamber 50 that is not the same as the angle defined by the upper facings of triangular island 32. In some aspects, the jets B will enter the chamber 50 at an angle that is not directed at the island 32 (instead, the angles of jets B from each power nozzle 43 will intersect before contacting the bottom facing of island 32), with that intersection occurring in the sloping portion 52 in certain aspects.

Each of the power nozzles 41, 42, 43 terminate at a cold step 51 as the fluid jets they produce C, M, B (respectively speaking) enter the chamber 50. Upstream from that cold step 51, each power nozzle 41, 42, 43 has a tapered or narrowing shape (as can best be seen in FIG. 2). Thus, the structures defining the power nozzles 41, 42, 43 (e.g., islands 30 and/or the boundary wall 11 disposed proximate the bottom edge of the insert 1) will have straight wall sections that angle inward as the flow is directed toward chamber 50. This narrowing or tapering is a significant feature for power nozzles, so as not to be confused with other structures that serve different purposes (both in fluidics and in other art fields). In some aspects, the angle formed between the tapering walls defining each of the power nozzles 41, 42, 43 may vary from between 2° to 25°, with selected aspects having an angle of 15° (+/−) 5°.

The foregoing arrangement of islands 30, nozzles 50, and chamber 50 (including the cold step 51 and sloping portion 52) create flow patterns that enable operation at comparatively lower temperatures than could be maintained by conventional designs. Particularly to the extent circuit 10 finds utility in automotive and sensor cleaning applications where low temperatures (below freezing and sometimes dropping even lower than −20° C., as defined below), the foregoing five-jet island is a marked improvement in the field of fluidics. Further, the components above can be adjusted to produce specific, desired effects within the spray fan, all while maintaining operability across a wide range of temperatures in fluids having viscosities similar to aqueous and/or alcohol-based cleaning solutions.

In view of the conventional solutions identified in the Background section above, it will be understood that seemingly minor changes in number, shape, and/or structures of a fluidic circuit can and often do have significant and sometimes unpredicted impacts. Therefore, the absence of additional features in the circuit 10 is significant, particularly with respect to the area between the interaction region and the inlet region. In the same manner, the use of straight sidewalls on the boundary wall 11, curved corners for the boundary wall 11, rounded edges at the transition points for all of the islands 30, and other aspects illustrated in the Figures may also form distinct aspects of the invention.

In one particular aspect, a fluidic device is contemplated. The device includes an insert body having a flat planar shape including a major facing, with a central axis extending from an upstream edge to a downstream edge. A boundary wall surrounds a fluidic circuit along the upstream edge, parallel side edges, and the downstream edge except for a portion of the downstream edge where an outlet is provided. An inlet region is positioned within the boundary wall along the upstream edge, while an interaction chamber, forms part of the fluidic circuit and is interposed between the inlet region and the outlet. The interaction chamber has a shape defined two lower islands, two upper islands, and a bottom wall, with a triangular island positioned within the shape and with a throat positioned within the bottom wall so as to fluidically connect the interaction chamber to the outlet. A series of power nozzles are part of the fluidic circuit, and the series of power nozzles include: i) a central power nozzle defined by an opening between the two upper islands, ii) a pair of opposing midrange power nozzles defined by openings between each upper island and lower island, and iii) a pair of opposing lower power nozzles defined by openings between each lower island and the bottom wall. The device may also include any one or combination of the following features:
wherein a cold step is positioned at each of the series of power nozzles so that the interaction chamber has a greater depth in comparison to a depth of a region immediately upstream from the interaction chamber;
wherein a sloping section is provided in a downstream portion of the interaction chamber, with the sloping region having a variable depth that is less than the depth of the interaction chamber but greater than the depth of the region immediately upstream from the interaction chamber;
wherein the triangular island is positioned in an upstream portion of the interaction chamber and wherein the depth of the interaction chamber in the upstream portion remains constant;
wherein a transverse width of the interaction chamber is greatest along a line orthogonal to the central axis between opposing inner facings of each of the two lower islands;
wherein an axial length of the interaction chamber is greatest along a line parallel to the central axis between an inner facing of one of the two upper islands and the bottom wall;
wherein the interaction chamber includes two separate sections having equal and greatest axial length so as to impart a four leaf clover shape to the shape of the interaction chamber;
wherein the triangular island is centered on the central axis;
wherein at least one of the two lower islands and the two upper islands form mirror images about the central axis;
wherein the bottom wall is parallel to the downstream edge of the insert;
wherein the two upper islands have an L- or a C-shape;
wherein jets emitted from each of the central power nozzle and the midrange power nozzles are directed at the triangular island, whereas jets emitted from the lower power nozzles intersect at a point downstream from the triangular island;
wherein each of the series of power nozzles has a tapering shape;
wherein all features constituting the boundary wall, the interaction chamber, and the outlet are symmetrical about the central axis; and
wherein jets emitted from each of the lower power nozzles are oriented upstream.

With the growing prominence/need for cleaning of sensors and camera systems, particularly in vehicles, there is a growing need for fluidic circuits that are capable of producing and maintaining spray characteristics over a range of temperatures (e.g., from −30° C. up to 75° C.) and fluid types (e.g., water, ethanol, methanol, isoproponal, ethylene glycol, etc.). Similarly, these systems may need to accommodate fluids having different viscosities (e.g., 9 cP up to 23 CP or more), as well as being provided over a range of flow rates (e.g., less than 400 mL/min at 22 psi). Generally speaking, “alcohol” will refer to pure alcohol, mixtures of water and alcohol(s), and mixtures of aqueous cleaning fluid (i.e., having additional additives) and alcohol(s).

Notably, in the automotive industry, anti-freezing agents used in cleaning solutions will vary by region and/or regulatory scheme. Thus, various alcohols (ethanol, isopropanol, methanol, etc.) may be mixed with water or other aqueous/miscible solutions at a variety of ratios (e.g., 50/50, 75/25, etc.). Further, insofar as operating conditions routinely vary from −20° C. up to in excess of 45° or 50° C., the viscosity of fluids passing through the fluidic geometry can vary by a factor of 3 or more (with higher viscosities encountered at lower temperatures). As used herein, low temperature performance means that the spray fans (in terms of size and volume of fluid delivered) remain comparatively constant at the upper and lower ends of these ranges, although automobile manufacturers place a premium on performance at ambient/mid-range and low temperatures, with the five jet island designs contemplated herein doing particularly well when dispensing alcohol-based mixtures.

All components should be made of materials having sufficient flexibility and structural integrity, as well as a chemically inert nature and resistant to corrosion and other conditions commonly encountered by exterior vehicle components. Certain grades of injection-moldable polymers may be particularly advantageous, as will various processes for forming detailed shapes in/on metallic, polymeric, composite, or other types of blocks of materials.

References to coupling in this disclosure are to be understood as encompassing any of the conventional means used in this field. This may take the form of snap- or force fitting of components, although threaded connections, bead-and-groove, and bayonet-style/slot-and-flange assemblies could be employed. Adhesive and fasteners could also be used, although such components must be judiciously selected in view of the design considerations noted above.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

We claim:

1. A fluidic device comprising:
an insert body having a flat planar shape including a major facing, with a central axis extending from an upstream edge to a downstream edge;
a boundary wall surrounding a fluidic circuit along the upstream edge, parallel sidewalls and the downstream edge except for a portion of the downstream edge where an outlet is provided;
an inlet region positioned within the boundary wall along the upstream edge;
an interaction chamber, forming part of the fluidic circuit and interposed between the inlet region and the outlet, having a shape defined two lower islands, two upper islands, and a bottom wall, with a triangular island positioned within the shape and with a throat positioned within the bottom wall so as to fluidically connect the interaction chamber to the outlet; and
wherein a series of power nozzles include: i) a central power nozzle defined by an opening between the two upper islands, ii) a pair of opposing midrange power nozzles defined by openings between each upper island and lower island, and iii) a pair of opposing lower power nozzles defined by openings between each lower island and the bottom wall.

2. The fluidic device of claim 1 wherein a cold step is positioned at each of the series of power nozzles so that the interaction chamber has a greater depth in comparison to a depth of a region immediately upstream from the interaction chamber.

3. The fluidic device of claim 2 wherein a sloping section is provided in a downstream portion of the interaction chamber, with the sloping region having a variable depth that is less than the depth of the interaction chamber but greater than the depth of the region immediately upstream from the interaction chamber.

4. The fluidic device of claim 3 wherein the triangular island is positioned in an upstream portion of the interaction chamber and wherein the depth of the interaction chamber in the upstream portion remains constant.

5. The fluidic device of claim 2 wherein a transverse width of the interaction chamber is greatest along a line orthogonal to the central axis between opposing inner facings of each of the two lower islands.

6. The fluidic device of claim 2 wherein an axial length of the interaction chamber is greatest along a line parallel to the central axis between an inner facing of one of the two upper islands and the bottom wall.

7. The fluidic device of claim 6 wherein the interaction chamber includes two separate sections having equal and greatest axial length so as to impart a four leaf clover shape to the shape of the interaction chamber.

8. The fluidic device of claim 2 wherein the triangular island is centered on the central axis.

9. The fluidic device of claim 2 wherein at least one of the two lower islands and the two upper islands form mirror images about the central axis.

10. The fluidic device of claim 2 wherein the two upper islands have an L- or a C-shape.

11. The fluidic device of claim 2 wherein jets emitted from each of the central power nozzle and the midrange power nozzles are directed at the triangular island, whereas jets emitted from the lower power nozzles intersect at a point downstream from the triangular island.

12. The fluidic device of claim 1 wherein the bottom wall is parallel to the downstream edge of the insert.

13. The fluidic device of claim 1 wherein all features of the boundary wall, the interaction chamber, and the outlet are symmetrical about the central axis.

14. The fluidic device of claim 1 wherein each of the series of power nozzles has a tapering shape.

15. The fluidic device of claim 1 wherein jets emitted from each of the lower power nozzles are oriented upstream.
